(19) United States
(12) Patent Application Publication
(10) Pub. No.: US 2024/0228775 A9
(43) Pub. Date: Jul. 11, 2024

(54) FOOTWEAR WITH MULTI-MATERIAL OUTSOLE

(71) Applicant: Tingley Rubber Corporation, Piscataway, NJ (US)

(72) Inventors: James P. Towey, Nutley, NJ (US); Robert N. Petersen, Somerset, NJ (US); Steven A. Smith, Pompton Plains, NJ (US); Timothy L. Cullen, Cedar Knolls, NJ (US)

(73) Assignee: Tingley Rubber Corporation, Piscataway, NJ (US)

(21) Appl. No.: 18/380,264

(22) Filed: Oct. 16, 2023

Related U.S. Application Data
(60) Provisional application No. 63/417,788, filed on Oct. 20, 2022.

(51) Int. Cl. C08L 75/04; A43B 1/10; A43B 13/04; A43B 13/12; C08L 9/02

(52) U.S. Cl. CPC C08L 75/04; A43B 1/10; A43B 13/04; A43B 13/122; C08L 9/02

(57) ABSTRACT

A footwear article comprises: an outsole comprising: an outsole body comprising a first polyurethane polymeric material attached to one or more tread cleats comprising a nitrile butadiene rubber polymeric material; and a footwear upper affixed to the outsole, the footwear upper comprising a second polyurethane polymeric material. Footwear articles, including boots, overshoes, and/or work shoes, are effective to meet or exceed slip resistance in accordance with ASTM F3445-21. Methods of making the footwear articles are also described.

### CROSS-REFERENCE TO RELATED APPLICATION

This application claims priority under 35 U.S.C. § 119(e) to U.S. Provisional Application No. 63/417,788, filed Oct. 20, 2022, the disclosure of which is incorporated herein by reference in its entirety.

### TECHNICAL FIELD

The present disclosure generally relates to footwear, namely boots, overshoes, and/or work shoes, having an outsole made from two or more types of materials. In particular, the outsole comprises an outsole body comprising one type of polymeric material, for example, a polyurethane polymeric material, which is attached to one or more tread cleats of another type of polymeric material, for example, a nitrile butadiene rubber (NBR) polymeric material.

### BACKGROUND

Liquid protection footwear, namely boots, are designed to protect feet and lower leg portions against infusion of liquid during wet surface conditions. Polymeric materials are suitable for forming liquid protection footwear, namely boots, and polymer sources or raw materials are amenable to injection molding techniques. Polyurethane footwear is desirable as offering liquid proof protection, along with being lightweight as compared to polyvinyl chloride (PVC) and traditional rubber footwear, and with being chemical and abrasion resistant.

Outsoles that are fabricated entirely with a polyurethane polymeric material do not always offer acceptable slip resistance under wet surface conditions.

As of July 2021, a performance specification in accordance with ASTM F3445-21 establishes minimum coefficient of friction requirements to label footwear as “SR” (Slip Resistant) in the United States. In this way, slip performance of various articles of footwear, including safety boots, under various surface conditions can be compared.

There is an on-going need to provide footwear, in particular, liquid proof boots, that provide slip resistance.

### SUMMARY

Provided are articles of footwear, namely, boots, overshoes, and/or work shoes with multi-material outsoles. The outsoles herein comprise two different materials: a polyurethane polymeric material and a nitrile butadiene rubber (NBR) polymeric material.

In an aspect, an article of footwear comprises: an outsole comprising: an outsole body comprising a first polyurethane polymeric material attached to one or more tread cleats comprising a nitrile butadiene rubber polymeric (NBR) material; and a footwear upper affixed to the outsole, the footwear upper comprising a second polyurethane polymeric material. In some instances, the first polyurethane polymeric material of the outsole body is the same as the second polyurethane polymeric material of the footwear upper. In other instances, the first polyurethane polymeric material of the outsole body is different from the second polyurethane polymeric material of the footwear upper.

In a detailed aspect, liquid protection boot comprises: an outsole comprising: an outsole body comprising a first polyurethane polymeric material, the outsole body being overmolded and directly attached to two or more compression-molded tread cleats, the tread cleats comprising a nitrile butadiene rubber (NBR) polymeric material; and a liquid proof footwear upper affixed to the outsole, the footwear upper comprising a second polyurethane polymeric material different from the first polyurethane polymeric material. The liquid protection boot comprises one or more of the following: a coefficient of friction of greater than or equal to 0.4 between a forward heel and a dry surface as measured by ASTM F2913-19, a coefficient of friction of greater than or equal to 0.4 between a forward heel and a wet surface as measured by ASTM F2913-19, a coefficient of friction of greater than or equal to 0.4 between a backward forepart and a dry surface as measured by ASTM F2913-19; and/or a coefficient of friction of greater than or equal to 0.4 between a backward forepart and a wet surface as measured by ASTM F2913-19.

A further aspect is a method of making a boot comprising: positioning one or more compression-molded tread cleats comprising a nitrile butadiene rubber polymeric material into one or more respective cavities of an outsole portion of a footwear mold; injecting a first two-component polyurethane source into the outsole portion of the footwear mold and over the one or more compression-molded tread cleats; injecting a second two-component polyurethane source into an upper portion of the footwear mold; heating the footwear mold curing both the first and second two-component polyurethane sources to direct-attach an outsole body comprising a first polyurethane polymeric material that is overmolded to the one or more compression-molded tread cleats with a footwear upper comprising a second polyurethane polymeric material; and removing the article of footwear from the footwear mold.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments. The embodiments as described herein are illustrated by way of example and not limitation in the figures of the accompanying drawings in which like references indicate similar elements. The figures herein are not to scale.

FIG. 1 is a schematic side view of a boot according to an embodiment;

FIG. 2 is a schematic bottom view of an outsole according to another embodiment;

FIG. 3 is a schematic bottom view of an outsole according to an embodiment;

FIG. 4 is a schematic bottom view of a prior art outsole; and

FIG. 5 is a flowchart of a method of making a boot in accordance with one or more embodiments of the disclosure.

### DETAILED DESCRIPTION

Before describing several exemplary embodiments of the disclosure, it is to be understood that the disclosure is not limited to the details of construction or process steps set forth in the following description. The disclosure is capable of other embodiments and of being practiced or being carried out in various ways.

Footwear disclosed herein have an advantage in that the outsoles comprise: an outsole body comprising a polyurethane polymeric material attached to one or more tread cleats comprising a nitrile butadiene rubber polymeric material. The outsole is affixed to a footwear upper, which is made of a polyurethane polymeric material. In one or more embodiments, the polyurethane polymeric material of the footwear upper is the same material as the polyurethane polymeric material of the outsole body. In one or more embodiments, the polyurethane polymeric material of the footwear upper is a different material from the polyurethane polymeric material of the outsole body. In other more embodiments, the polyurethane polymeric material of the footwear upper is the same material as the polyurethane polymeric material of the outsole body. The footwear, namely boots, herein offer slip resistance that meets and/or exceeds the requirements of ASTM F3445-21.

ASTM F3445-21 is entitled “Standard Specification for Performance Requirements when Evaluating Slip Resistance of Protective (Safety) Footwear using ASTM F2913 Whole Shoe Test Method.” Per ASTM F3445-21, the performance requirement is that “[e]ach footwear specimen shall have a COF of no less than 0.40 when tested in both heel and forepart modes using wet and dry quarry tile. The COF is the [arithmetic] mean (average) of five consecutive results for each specimen when tested per Test Method F2913.” The ASTM F3445-21 requires testing of a US men's size 9 sample.

Many types of footwear may benefit from the multi-material outsoles disclosed herein, including but not limited to boots, including mid-calf boots and knee boots, overshoes, and work shoes.

Reference herein to “mid-calf boot” refers to footwear designed to protect feet and lower legs, with a top of the boot extending nominally to the middle of a wearer's calf. A boot that is a mid-calf boot covers a portion of a wearer's calf. In one or more embodiments, a topline of the mid-calf boot is positioned within 0-2 inches of a the wearer's lower calf.

Reference herein to “knee boot” refers to footwear designed to protect feet and lower legs, with a top of the boot extending nominally towards a wearer's knee. That is, a boot that is a knee boot covers all or almost all of a wearer's calf and may extend to the general area to or at or below a base of the wearer's knee. In one or more embodiments, a topline of the knee boot is positioned within 0-2 inches of the base of the wearer's knee.

Reference to “attached” means that an item connects to another item by injection molding techniques or by affixing using an adhesive material (e.g., epoxy or glue). In one or more non-limiting embodiments, one or more tread cleats are pre-fabricated, e.g., compression-molded, placed in an outsole portion of a footwear mold, and a polymer source for the outsole body is injected over and/or around portions of the tread cleats by direct attachment injection techniques. The tread cleats are thereby attached to the outsole body. During overmolding, adhesion of the polymer source for the outsole body (e.g., polyurethane) directly to the one or more tread cleats (e.g., NBR) facilitates the attachment.

In a footwear mold, a footwear upper and an outsole body may be fabricated by injection molding each in close proximity each other, preferably in the same mold, whereupon heating/curing, the footwear upper is attached to the outsole body by direct attachment injection techniques. In one or more embodiments, the outsole body is fabricated first and the footwear upper is fabricated thereafter and direct-attached to the outsole body. In one or more other embodiments, the footwear upper is fabricated first and the outsole body is fabricated thereafter and direct-attached to the footwear upper. It is understood that some intermingling of the individual injection-molded polymer sources upon curing may occur to facilitate the attachment.

Reference to “directly attached” or “direct-attached” means that an item connects to another item without any intervening item, e.g. a layer of an adhesive material, therebetween. In one or more embodiments, the outsole body is directly attached to the one or more tread cleats. In one or more embodiments, the outsole body is directly attached to the one or more tread cleats by being overmolded to the tread cleats in the absence of an adhesive material.

A “tread cleat” is a feature of an outsole. The tread cleats and/or outsole body may have protrusions and/or recesses designed to interact with walking surfaces. For example, recesses may channel or direct liquids out of the way. Protrusions may offer traction on the walking surface. The tread cleats and outsole body afford the wearer slip resistance over a wide range of surfaces. In one or more embodiments, the outsole comprises multiple tread cleats including 1, 2, 3, 4, 5, 6, 7, 8, 9, 10, or more.

Reference to a “polymer source”, for example a “polyurethane source” or a “two-component polyurethane source” means the substance in its raw form utilized in the manufacturing process. Upon processing in the manufacturing process, the polymer source yields a structure that is a polymeric material. For example, a two-component polyurethane polymer source may be supplied in liquid form by gravity feed of two separate ingredients (isocyanate and a polyol), which are combined to react to form the polyurethane source, which is then injection-molded, cured, and cooled to form a structure, which comprises a polyurethane polymeric material.

Polyurethane (PU) herein means a polymer with urethane linkages [NH—(C═O)—O], which is prepared by a two-component system of isocyanate and polyol, optionally in the presence of catalyst(s) and/or processing aids. For the purposes of this disclosure, a thermoplastic polyurethane (TPU), which is an elastomer, is a different material from polyurethane. Generally, a difference between TPU and PU is that TPU has no cross-links whereas PU can have cross-links based on the type of polyols used. For the purposes of this disclosure, natural or synthetic rubber (e.g., polyisoprene) is a different material from polyurethane.

Before describing several exemplary embodiments of the invention, it is to be understood that the invention is not limited to the details of construction or process steps set forth in the following description. The invention is capable of other embodiments and of being practiced or being carried out in various ways.

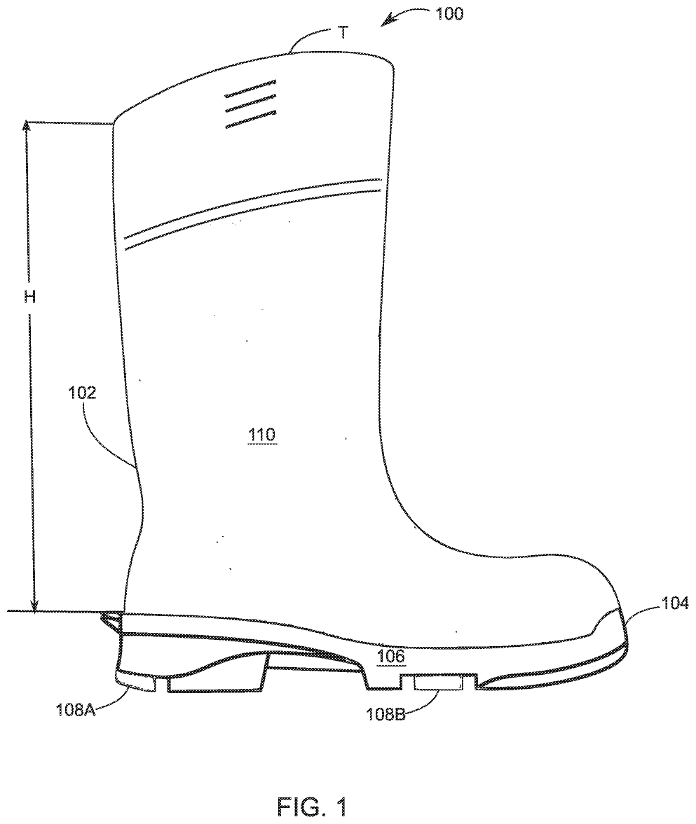

Turning to the figures, FIG. 1 is a schematic side view of a boot 100 comprising a footwear upper 102 comprising an upper body 110, and an outsole 104. The footwear upper 102 is affixed to the outsole 104 and in this non-limiting embodiment is designed for providing a knee boot in that, without being limited by an exact length or location on a wearer, the boot extends to the general area to or at or below a wearer's knee. In one or more embodiments, a topline “T” of the knee boot is positioned within 0-2 inches (and all values and subranges therebetween) of the wearer's knee.

The footwear upper 102 has a rear height “H” as denoted in FIG. 1, along a rear side of the footwear upper 102. The footwear upper 102 comprises a polymeric material. In one or more embodiments, the polymeric material of the upper body 110 is a polyurethane polymeric material. In one or more embodiments, the polyurethane polymeric material of the footwear upper 102 comprises an ether-based polyurethane, that is, the polyol of the respective two-component polyurethane source is an ether (e.g., a polyether triol). Ether-based PUs offer low water absorption resulting in moisture resistance against hydrolysis and fungi resistance. Also, ether-based PUs offer low temperature resistance (i.e., resists degradation and brittleness upon exposure to cold) and ultraviolet resistance.

The footwear upper 102 in one or more embodiments is liquid- and/or waterproof. The footwear upper 102 may contain additional features as desired, such as heel kicks, bands, grips, inner texture, and the like to facilitate donning and removing of the boot 100.

The outsole 104 comprises an outsole body 106 and one or more tread cleats 108. In a non-limiting example, the outsole 104 comprises two tread cleats 108A, 108B.

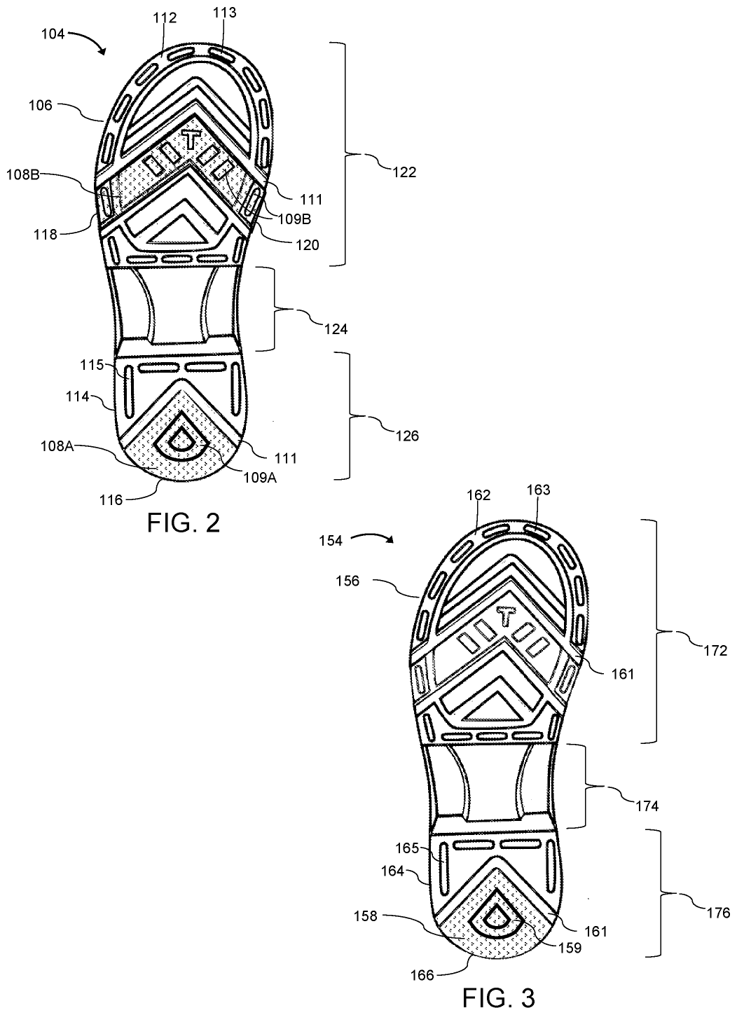

Turning to FIG. 2, a schematic bottom view of the outsole 104 shows three areas in this embodiment: a forepart section 122, an arch-shank section 124, and a heel section 126. The outsole 104 comprises the outsole body 106 and two tread cleats 108A, 108B. The tread cleat 108A is positioned at a heel 114 of the outsole 104, which is part of the heel section 126. The tread cleat 108A contacts a surface and influences traction, along with the heel section 126 generally, during a forward heel slip coefficient of friction test method (e.g., ASTM F2913-19). As shown in FIG. 2, in one or more embodiments, the tread cleat 108A continuously follows a portion of the heel 114 of the outsole 104 along a rear edge 116. The tread cleat 108B is positioned at in the forepart section 122 of the outsole 104. The tread cleat 108B contacts a surface and influences traction, along with the forepart section 122 generally, during a backward forepart slip coefficient of friction test method (e.g., ASTM F2913-19). As shown in FIG. 2, in one or more embodiments, the tread cleat 108B spans continuously from one side edge 118 to another side edge 120.

Turning to FIG. 3, a schematic bottom view of another exemplary outsole 154 shows three areas in this embodiment: a forepart section 172, an arch-shank section 174, and a heel section 176. The outsole 154 comprises an outsole body 156 and one tread cleat 158. The tread cleat 158 is positioned at a heel 164 of the outsole 154, which is part of the heel section 176. The tread cleat 158 contacts a surface and influences traction, along with the heel section 176 generally, during a forward heel slip coefficient of friction test method (e.g., ASTM F2913-19). As shown in FIG. 3, in one or more embodiments, the tread cleat 158 continuously follows a portion of the heel 164 of the outsole 154 along a rear edge 166.

With reference to FIGS. 2-3, for liquid protection and slip resistance purposes, the outsole 104, 154 is a combination of first and second polymeric materials, which are suitable for a variety of ground surfaces and surface conditions. The outsole 104, 154 is made up of two structures: outsole body 106, 156 of a first polymeric material; and tread cleats 108A, 108B, 158, of a second polymeric material. In one or more embodiments, the polymeric material of the outsole body 106, 156 is a polyurethane polymeric material. In one or more embodiments, the polyurethane polymeric material of the outsole body 106, 156 comprises an ester-based polyurethane that is, the polyol of the respective two-component polyurethane source is an ester (e.g., a polyester). Ester-based PUs are slightly more rigid and supportive as compared to ether-based PUs. In one or more embodiments, the polyurethane polymeric material of the outsole body 106, 156 has characteristics of: a tensile strength in a range of greater than or equal to 900 psi to less than or equal to 1100 psi; a modulus in a range of less than or equal to 300 psi to greater than or equal to 200 psi; and/or a specific gravity in a range of greater than or equal to 0.55 g/ml to less than or equal to 0.95 g/ml. In one or more embodiments, the polyurethane polymeric material of the outsole body 106, 156 is different from the polyurethane polymeric material of the upper body 110.

The tread cleats 108A, 108B, 158 are separately fabricated before injection molding of the footwear article. In one or more embodiments, the tread cleats 108A, 108B, 158 are compression-molded according to desired design features. The tread cleats 108A, 108B, 158 are positioned into one or more respective cavities of an outsole portion of a footwear mold. In one or more embodiments, integrally-formed design features of the tread cleats 108A, 108B, 158 include one or more recesses: e.g., channel 109A, and traction holes 109B, 159. Non-recessed parts of the tread cleats 108A, 108B, 158 have the potential to touch, and are generally in contact with, the ground surface during regular use. The tread cleats 108A and 158 are also known as heel strikes. In one or more embodiments, the nitrile butadiene rubber polymeric material of the tread cleats 108A, 108B, 158 has characteristics of: a tensile strength in a range of greater than or equal to 1025 psi to less than or equal to 2700 psi; a modulus in a range of less than or equal to 350 psi to greater than or equal to 255 psi; and/or a specific gravity in a range of greater than or equal to 1.0 g/ml to less than or equal to 1.5 g/ml.

In one or more embodiments, the outsole body 106, 156 is injection-molded in the outsole portion of the footwear mold and overmolded to the tread cleats 108A, 108B, 158. One or more integrally-formed design features of the outsole body 106, 156 include but are not limited to: a toe 112, 162; the heel 114, 164; and one or more recesses: traction holes 113, 163, 115, 165, channels 111, 161 (for simplicity not all of the recesses are numbered). In one or more embodiments, the arch-shank section 124, 174 is integrally-formed with the outsole body. Other embodiments may provide for a separately-affixed arch-shank area. The recessed parts 111, 161, 113, 163, 115, 165, 124, 174 of the outsole body 106, 156 do not generally have the potential to be in contact with the ground surface during use.

As to the outsole 104, 154, for purposes of analyzing surface area as it relates to measurement of slip resistance (e.g., a “slip resistance” surface area) the following protocol is adopted. An area that is recessed, which does not have the potential to touch the ground during regular use is not included. With reference to FIGS. 2-3, this means that areas of the arch-shank section 124, 174 and of the recesses (109A, 109B, 111, 113, 115, 159, 161, 163, 165) are not included. Surface areas of regions of the forepart section 122, 172 and the heel section 126, 176, e.g., portions of tread cleats/NBR versus outsole body/PU were analyzed (without inclusion of any recessed areas, e.g., traction holes or channels) using software designed for area measurement capability.

In one or more embodiments, a surface area of a forepart section of the outsole comprises: greater than or equal to 20% to less than or equal to 30% of the tread cleats, including at least 23%, and all values and subranges therebetween. In one or more embodiments, a surface area of the forepart section of the outsole comprises: greater than or equal to 70% to less than or equal to 80% of the outsole body, including at most 77%, and all values and subranges therebetween. In one or more embodiments, a surface area of the forepart section of the outsole comprises: greater than or equal to 20% to less than or equal to 30% of the tread cleats, including at least 23%, and all values and subranges therebetween; and greater than or equal to 70% to less than or equal to 80% of the outsole body, including at most 77%, and all values and subranges therebetween.

In one or more embodiments, a surface area of a forepart section of the outsole comprises: greater than or equal to 20% to less than or equal to 30% of nitrile butadiene rubber (NBR) polymeric material, including at least 23%, and all values and subranges therebetween. In one or more embodiments, a surface area of the forepart section of the outsole comprises: greater than or equal to 70% to less than or equal to 80% of the first polyurethane polymeric material, including at most 77%, and all values and subranges therebetween. In one or more embodiments, a surface area of the forepart section of the outsole comprises: greater than or equal to 20% to less than or equal to 30% of the nitrile butadiene rubber (NBR) polymeric material, including at least 23%, and all values and subranges therebetween; and greater than or equal to 70% to less than or equal to 80% of first polyurethane polymeric material, including at most 77%, and all values and subranges therebetween.

In one or more embodiments, a surface area of a heel section of the outsole comprises: greater than or equal to 20% to less than or equal to 45% of the tread cleats, including at least 21%, and all values and subranges therebetween. In one or more embodiments, a surface area of the heel section of the outsole comprises: greater than or equal to 55% to less than or equal to 80% of the outsole body, including at most 79%, and all values and subranges therebetween. In one or more embodiments, a surface area of the heel section of the outsole comprises: greater than or equal to 20% to less than or equal to 45% of the tread cleats, including at least 21%, and all values and subranges therebetween; and greater than or equal to 55% to less than or equal to 80% of the outsole body, including at most 79%, and all values and subranges therebetween.

In one or more embodiments, a surface area of a heel section of the outsole comprises: greater than or equal to 20% to less than or equal to 45% of nitrile butadiene rubber (NBR) polymeric material, including at least 21%, and all values and subranges therebetween. In one or more embodiments, a surface area of the heel section of the outsole comprises: greater than or equal to 55% to less than or equal to 80% of the first polyurethane polymeric material, including at most 79%, and all values and subranges therebetween. In one or more embodiments, a surface area of the heel section of the outsole comprises: greater than or equal to 20% to less than or equal to 45% of the nitrile butadiene rubber (NBR) polymeric material, including at least 21%, and all values and subranges therebetween; and greater than or equal to 55% to less than or equal to 80% of first polyurethane polymeric material, including at most 79%, and all values and subranges therebetween.

FIG. 5 is a flowchart of a method of making a boot 500 in accordance with one or more embodiments of the disclosure. At operation 505, compression-molded tread cleats comprising a nitrile butadiene rubber (NBR) polymeric material are positioned into one or more respective cavities of an outsole portion of a footwear mold. At operation 510, a first two-component polyurethane source is injected into the outsole portion of the footwear mold. At this point, the first two-component polyurethane source of the outsole is in contact with the one or more compression-molded tread cleats, at e.g., exposed surfaces of each of the cleats. The first two-component polyurethane source of the outsole is injected over the tread cleats. At operation 515, a second two-component polyurethane source is injected into an upper portion of the footwear mold. In one or more embodiments, operation 510 is conducted before operation 515. Upon completion of operations 510 and 515, the separately injected portions are in contact with each other. At operation 520, the footwear mold is heated, which may be occurring simultaneously with operations 510 and 515, respectively. At operation 525, both the first and second two-component polyurethane sources are cured under the processing conditions, e.g., temperature and pressure. The first and second two-component polyurethane sources in turn result in first and second polyurethane polymeric material. In one or more embodiments, the first two-component polyurethane source injected into the outsole portion yields an outsole body of a first polyurethane polymeric material. In one or more embodiments, the second two-component polyurethane source injected into the upper portion yields a footwear upper of a second polyurethane polymeric material. The article of footwear is in turn prepared, where the outsole body comprising the first polyurethane polymeric material that is overmolded to the one or more compression-molded tread cleats is direct-attached with the footwear upper comprising the second polyurethane polymeric material. Thereafter, the article of footwear is removed from the footwear mold at operation 530.

The article of footwear cools thereafter, which may be achieved upon discharge from the footwear mold and exposure to ambient conditions, or by other techniques known in the art.

Advantageously, the footwear herein comprise an outsole body comprising a polyurethane polymeric material attached to one or more tread cleats comprising a nitrile butadiene rubber polymeric material, where the polyurethane polymeric material and the nitrile butadiene rubber polymeric material are compatible. Upon overmolding of the polyurethane polymeric material of the outsole body to the tread cleats, a strong bond, namely a chemical bond, forms, which eliminates a need to separately adhere the tread cleats by using glue or epoxy or the like. Use of incompatible materials (e.g., dissimilar polymers that do not readily bond) can disadvantageously lead to poor bonding and/or delamination. Poor bonding could result in cavities in which dirt, debris or other foreign materials can become lodged. In turn, such could lead to conveyance of said contaminants from one work area to another. Poor bonding could also lead to loose or dangling cleats that can present a trip hazard. Poor bonding could lead to premature failure of the boots.

### EXAMPLES

Various embodiments will be further clarified by the following examples.

As described below, polymer sources are injection molded and subsequently processed in accordance with methods known in the art to form structures of polymeric material. Processing can include heating and/or curing and/or cooling and/or other operations.

Polyurethane “A” is an ether-based polyurethane. Polyurethane “B” is an ester-based polyurethane. Polyurethane “C” is a polyurethane different from “A” or “B”.

Polyurethane “B” polymeric material and nitrile butadiene rubber (NBR) polymeric material of the examples were tested for tensile strength (representing) maximum elongation before breaking and modulus (determined at 100% elongation) in accordance with ASTM D412-16(2021), and specific gravity in accordance with ASTM D792-20. Shore Hardness A is determined by ASTM-D2240-15(2021). The results are provided in Table 1.

TABLE 1

| | | Tensile | | Specific |
|---|---|---|---|---|
| | Shore A | Strength | Modulus | Gravity |
| | hardness | (psi) | (psi) | (g/ml) |
| Polyurethane “B” | 50-55 | 999 | 243 | 0.639 |
| polymeric material | | | | |
| Nitrile Butadiene | 62-68 | 2382 | 287 | 1.18 |
| Rubber (NBR) | | | | |
| polymeric material | | | | |

### Example 1

A liquid proof knee boot was manufactured generally as depicted in FIG. 5. The outsole was generally in accordance with the design of FIG. 3 (one cleat in a heel section) made from one compression-molded tread cleat of a nitrile butadiene rubber (NBR) polymeric material and an outsole body of Polyurethane “B”. A boot upper comprised the Polyurethane “A”.

A surface area of the heel section of the outsole measured as discussed herein for slip resistance purposes comprised: approximately 58% polyurethane outsole body and approximately 42% NBR tread cleat. A surface area of the outsole as a whole comprised: approximately 87% polyurethane outsole body and approximately 13% NBR tread cleat.

### Example 2

A liquid proof knee boot was manufactured generally as depicted in FIG. 5. The boot upper was consistent with Example 1. The outsole was generally in accordance with the design of FIG. 2 made from two compression-molded tread cleats of the nitrile butadiene rubber (NBR) polymeric material an outsole body of Polyurethane “B” polymeric material.

A surface area of the heel section of the outsole measured as discussed herein for slip resistance purposes comprised: approximately 58% polyurethane outsole body and approximately 42% NBR tread cleat. A surface area of the forepart section of the outsole measured comprised: approximately 81% polyurethane outsole body and approximately 19% NBR tread cleat. A surface area of the outsole as a whole comprised: approximately 68% polyurethane (PU) outsole body and approximately 32% NBR tread cleats.

### Example A

### Comparative

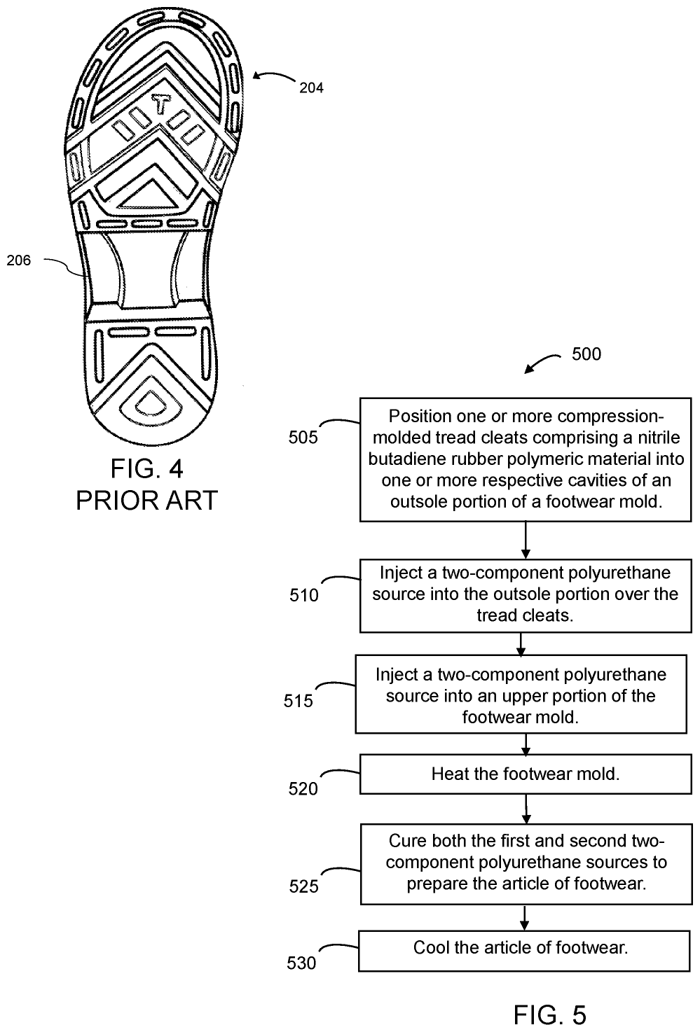

A comparative liquid proof knee boot was manufactured generally as depicted in FIG. 5 with the exception of omitting operation 505. The boot upper was consistent with Example 1. The outsole was made by entirely filling an outsole portion of the footwear mold with the first polyurethane polymer source and subsequent processing to create an outsole of entirely Polyurethane “B” polymeric material. The outsole portion of the footwear mold had a design analogous to that of FIG. 4 PRIOR ART. A surface area of the outsole accordingly comprised: 100% first polyurethane polymeric material outsole body and tread cleats.

### Example B

### Comparative

A comparative liquid proof knee boot commercially available that included a 100% Polyurethane “B” outsole with a different pattern from FIG. 4 was acquired.

### Example C

### Comparative

A comparative liquid proof knee boot commercially available included a 100% Polyurethane “C” outsole with a different pattern from FIG. 4 was acquired.

### Example 3

### Testing

The knee boots of Examples 1-2 and Examples A-C were tested in accordance with ASTM F2913-19 and compared to the minimum ASTM F3445-21 requirements. The results are provided in Table 2.

TABLE 2

| | | | ASTM F2913-19 Whole shoe slip 500N | | | |
|---|---|---|---|---|---|---|
| | | # tread | Forward | | Backward | |
| | | cleats of | Heel Slip | | Forepart Slip | |
| | Outsole | different | Dry | Wet | Dry | Wet |
| | overall | material | Surface | Surface | Surface | Surface |
| ASTM | — | — | 0.40 | 0.40 | 0.40 | 0.40 |
| F3445-21 | | | | | | |
| Example 1 | 87% | 1 in heel | 0.65 | 0.59 | 0.44 | 0.42 |
| | polyurethane | section 58% | Exceed | Exceed | Exceed | Exceed |
| | body & 13% | polyurethane | | | | |
| | NBR | and 42% NBR | | | | |
| Example 2 | 68% | 2 1 in heel | 0.80 | 0.66 | 0.47 | 0.44 |
| | polyurethane | section 58% | Exceed | Exceed | Exceed | Exceed |
| | body & 32% | polyurethane | | | | |
| | NBR | and 42% NBR | | | | |
| | | 1 in forepart | | | | |
| | | section 81% | | | | |
| | | polyurethane | | | | |
| | | and 19% NBR | | | | |
| Example A | 100% | 0 | 0.43 | 0.39 | 0.43 | 0.41 |
| Comparative | polyurethane | | Exceed | Fail | Exceed | Exceed |
| | B | | | | | |
| Example B | 100% | 0 | 0.46 | 0.38 | 0.52 | 0.46 |
| Comparative | polyurethane | | Exceed | Fail | Exceed | Exceed |
| | B | | | | | |
| Example C | 100% | 0 | 0.59 | 0.38 | 0.63 | 0.40 |
| Comparative | polyurethane | | Exceed | Fail | Exceed | Meet |
| | C | | | | | |

The knee boots of Examples 1-2 exceeded all of the slip requirements of ASTM F3445-21 for forward heel slip: wet and dry surfaces, and for backward forepart slip: wet and dry surfaces.

The knee boots of Examples A-C Comparative all failed the forward heel slip wet surface slip requirement.

The knee boots of Examples 1-2 and Examples A-C were further tested in accordance with ASTM F2913-19 with respect to other surfaces: oily, oily/wet, soapy/wet, soapy/oily/wet. The results are provided in Table 3.

TABLE 3

| | ASTM F2913-19 Whole shoe slip 500N | | | | | | | |
|---|---|---|---|---|---|---|---|---|
| | Forward Heel Slip | | | | Backward Forepart Slip | | | |
| | | | | Soapy/Oily | | | | Soapy/Oily |
| | Oily | Oily/Wet | Soapy/Wet | Wet | Oily | Oily/Wet | Soapy/Wet | Wet |
| | Surface | Surface | Surface | Surface | Surface | Surface | Surface | Surface |
| Example 1 | 0.24 | 0.27 | 0.59 | 0.46 | 0.25 | 0.28 | 0.45 | 0.45 |
| Example 2 | 0.29 | 0.33 | 0.60 | 0.44 | 0.27 | 0.30 | 0.45 | 0.44 |
| Example A | — | — | — | — | — | — | — | — |
| Comparative | | | | | | | | |
| Example B | 0.25 | 0.30 | 0.36 | 0.36 | 0.23 | 0.27 | 0.36 | 0.36 |
| Comparative | | | | | | | | |
| Example C | 0.18 | 0.21 | 0.35 | 0.32 | 0.24 | 0.27 | 0.34 | 0.34 |
| Comparative | | | | | | | | |

The knee boots of Example 2 showed a higher coefficient of friction compared to Examples B-C Comparative on all of the oily, oily/wet, soapy/wet, soapy/oily/wet surfaces for both forward heel slip.

### EMBODIMENTS

Embodiment (a). An article of footwear comprising: an outsole comprising a first polyurethane polymeric material attached to one or more tread cleats comprising a nitrile butadiene rubber polymeric (NBR) material; and a footwear upper affixed to the outsole, the footwear upper comprising a second polyurethane polymeric material; and.

Embodiment (b). The article of footwear of embodiment (a) effective to meet or exceed slip resistance in accordance with ASTM F3445-21.

Embodiment (c). The article of footwear of embodiment (a) comprising a coefficient of friction of greater than or equal to 0.4 between a forward heel and a dry surface as measured by ASTM F2913-19, and/or a coefficient of friction of greater than or equal to 0.4 between a forward heel and a wet surface as measured by ASTM F2913-19.

Embodiment (d). The article of footwear of embodiment (a) or (c) comprising a coefficient of friction of greater than or equal to 0.4 between a backward forepart and a dry surface as measured by ASTM F2913-19, and/or a coefficient of friction of greater than or equal to 0.4 between a backward forepart and a wet surface as measured by ASTM F2913-19.

Embodiment (e). The article of footwear of one of embodiments (a) to (d), wherein the footwear upper and the outsole body are directly attached to each other.

Embodiment (f). The article of footwear of one of embodiments (a) to (e), wherein the outsole body is directly attached to the one or more tread cleats.

Embodiment (g). The article of footwear of one of embodiments (a) to (f), wherein the first polyurethane polymeric material of the outsole body and the second polyurethane polymeric material of the footwear upper are different materials.

Embodiment (h). The article of footwear of one of embodiments (a) to (g), wherein the first polyurethane polymeric material of the outsole body comprises an ester-based polyurethane, and the second polyurethane polymeric material of the footwear upper comprises an ether-based polyurethane.

Embodiment (i). The article of footwear of one of embodiments (a) to (h), wherein the first polyurethane polymeric material of the outsole body comprises a tensile strength in a range of greater than or equal to 900 psi to less than or equal to 1100 psi, and/or the nitrile butadiene rubber polymeric material of the tread cleats comprises a tensile strength in a range of greater than or equal to 1025 psi to less than or equal to 2700 psi as measured by ASTM D412-16(2021).

Embodiment (j). The article of footwear of one of embodiments (a) to (i), wherein the first polyurethane polymeric material of the outsole body comprises a modulus in a range of less than or equal to 300 psi to greater than or equal to 200 psi, and/or the nitrile butadiene rubber polymeric material of the tread cleats comprises a modulus in a range of less than or equal to 350 psi to greater than or equal to 255 psi as measured by ASTM D412-16(2021).

Embodiment (k). The article of footwear of one of embodiments (a) to (j), wherein the first polyurethane polymeric material of the outsole body comprises a specific gravity in a range of greater than or equal to 0.55 g/ml to less than or equal to 0.95 g/ml, and/or the nitrile butadiene rubber polymeric material of the tread cleats comprises a specific gravity in a range of greater than or equal to 1.0 g/ml to less than or equal to 1.5 g/ml as measured by ASTM D792-20.

Embodiment (l). The article of footwear of one of embodiments (a) to (k), wherein the tread cleats are compression-molded.

Embodiment (m). The article of footwear of one of embodiments (a) to (1), wherein the outsole comprises a forepart section, an arch-shank section, and a heel section.

Embodiment (n). The article of footwear of embodiment (m), wherein a surface area of the heel section comprises greater than or equal to 20% to less than or equal to 45% of the tread cleats.

Embodiment (o). The article of footwear of embodiment (m) or (n), wherein a surface area of the heel section comprises at least 21% of the tread cleats.

Embodiment (p). The article of footwear of embodiment (m) or (n) or (o), wherein a surface area of the forepart section comprises greater than or equal to 20% to less than or equal to 30% of the tread cleats.

Embodiment (q). The article of footwear of embodiment (m) or (n) or (o) or (p), wherein a surface area of the forepart section comprises at least 23% of the tread cleats.

Embodiment (r). A liquid protection boot comprising: an outsole comprising: an outsole body comprising a first polyurethane polymeric material, the outsole body being overmolded and directly attached to two or more compression-molded tread cleats, the tread cleats comprising a nitrile butadiene rubber (NBR) polymeric material; and a liquid proof footwear upper affixed to the outsole, the footwear upper comprising a second polyurethane polymeric material different from the first polyurethane polymeric material; wherein the liquid protection boot comprises one or more of the following: a coefficient of friction of greater than or equal to 0.4 between a forward heel and a dry surface as measured by ASTM F2913-19, a coefficient of friction of greater than or equal to 0.4 between a forward heel and a wet surface as measured by ASTM F2913-19, a coefficient of friction of greater than or equal to 0.4 between a backward forepart and a dry surface as measured by ASTM F2913-19; and/or a coefficient of friction of greater than or equal to 0.4 between a backward forepart and a wet surface as measured by ASTM F2913-19.

Embodiment (s). The liquid protection boot of embodiment (r), which is effective to meet or exceed slip resistance in accordance with ASTM F3445-21.

Embodiment (t). The liquid protection boot of embodiment (r) or (s), including one or more of the following: the first polyurethane polymeric material of the outsole body comprises a tensile strength in a range of greater than or equal to 900 psi to less than or equal to 1100 psi, and/or the nitrile butadiene rubber polymeric material of the tread cleats comprises a tensile strength in a range of greater than or equal to 1025 psi to less than or equal to 2700 psi as measured by ASTM D412-16(2021); the first polyurethane polymeric material of the outsole body comprises a modulus in a range of less than or equal to 300 psi to greater than or equal to 200 psi, and/or the nitrile butadiene rubber polymeric material of the tread cleats comprises a modulus in a range of less than or equal to 350 psi to greater than or equal to 255 psi as measured by ASTM D412-16(2021); and/or the first polyurethane polymeric material of the outsole body comprises a specific gravity in a range of greater than or equal to 0.55 g/ml to less than or equal to 0.95 g/ml, and/or the nitrile butadiene rubber polymeric material of the tread cleats comprises a specific gravity in a range of greater than or equal to 1.0 g/ml to less than or equal to 1.5 g/ml as measured by ASTM D792-20.

Embodiment (u). A method of making an article of footwear comprising: positioning one or more compression-molded tread cleats comprising a nitrile butadiene rubber polymeric material into one or more respective cavities of an outsole portion of a footwear mold; injecting a first two-component polyurethane source into the outsole portion of the footwear mold; injecting a second two-component polyurethane source into an upper portion of the footwear mold and over the one or more compression-molded tread cleats; heating the footwear mold curing both the first and second two-component polyurethane sources to direct-attach an outsole body comprising a first polyurethane polymeric material that is overmolded to the one or more compression-molded tread cleats with a footwear upper comprising a second polyurethane polymeric material; and removing the article of footwear from the footwear mold.

Embodiment (v). The method of embodiment (u), including one or more of the following: the first polyurethane polymeric material of the outsole body comprises a tensile strength in a range of greater than or equal to 900 psi to less than or equal to 1100 psi, and/or the nitrile butadiene rubber polymeric material of the tread cleats comprises a tensile strength in a range of greater than or equal to 1025 psi to less than or equal to 2700 psi as measured by ASTM D412-16(2021); the first polyurethane polymeric material of the outsole body comprises a modulus in a range of less than or equal to 300 psi to greater than or equal to 200 psi, and/or the nitrile butadiene rubber polymeric material of the tread cleats comprises a modulus in a range of less than or equal to 350 psi to greater than or equal to 255 psi as measured by ASTM D412-16(2021); and/or the first polyurethane polymeric material of the outsole body comprises a specific gravity in a range of greater than or equal to 0.55 g/ml to less than or equal to 0.95 g/ml, and/or the nitrile butadiene rubber polymeric material of the tread cleats comprises a specific gravity in a range of greater than or equal to 1.0 g/ml to less than or equal to 1.5 g/ml as measured by ASTM D792-20.

Embodiment (w). The method of embodiment (u) or (v), wherein the article of footwear comprises one or more of the following:
a coefficient of friction of greater than or equal to 0.4 between a forward heel and a dry surface as measured by ASTM F2913-19,
a coefficient of friction of greater than or equal to 0.4 between a forward heel and a wet surface as measured by ASTM F2913-19,
a coefficient of friction of greater than or equal to 0.4 between a backward forepart and a dry surface as measured by ASTM F2913-19; and/or
a coefficient of friction of greater than or equal to 0.4 between a backward forepart and a wet surface as measured by ASTM F2913-19.

Embodiment (x). The method of one of embodiments (u) to (w), wherein the article of footwear is effective to meet or exceed slip resistance in accordance with ASTM F3445-21.

Reference throughout this specification to “one embodiment,” “certain embodiments,” “various embodiments,” “one or more embodiments” or “an embodiment” means that a particular feature, structure, material, or characteristic described in connection with the embodiment is included in at least one embodiment of the disclosure. Thus, the appearances of the phrases such as “in one or more embodiments,” “in certain embodiments,” “in various embodiments,” “in one embodiment” or “in an embodiment” in various places throughout this specification are not necessarily referring to the same embodiment of the disclosure. Furthermore, the particular features, structures, materials, or characteristics may be combined in any suitable manner in one or more embodiments.

Although the disclosure herein provided a description with reference to particular embodiments, it is to be understood that these embodiments are merely illustrative of the principles and applications of the disclosure. It will be apparent to those skilled in the art that various modifications and variations can be made to the present disclosure without departing from the spirit and scope thereof. Thus, it is intended that the present disclosure include modifications and variations that are within the scope of the appended claims and their equivalents.

What is claimed is:

1. An article of footwear comprising:
an outsole comprising: an outsole body comprising a first polyurethane polymeric material attached to one or more tread cleats comprising a nitrile butadiene rubber polymeric (NBR) material; and
a footwear upper affixed to the outsole, the footwear upper comprising a second polyurethane polymeric material.

2. The article of footwear of claim 1 effective to meet or exceed slip resistance in accordance with ASTM F3445-21.

3. The article of footwear of claim 1 comprising a coefficient of friction of greater than or equal to 0.4 between a forward heel and a dry surface as measured by ASTM F2913-19, and/or a coefficient of friction of greater than or equal to 0.4 between a forward heel and a wet surface as measured by ASTM F2913-19.

4. The article of footwear of claim 1 comprising a coefficient of friction of greater than or equal to 0.4 between a backward forepart and a dry surface as measured by ASTM F2913-19, and/or a coefficient of friction of greater than or equal to 0.4 between a backward forepart and a wet surface as measured by ASTM F2913-19.

5. The article of footwear of claim 1, wherein the footwear upper and the outsole body are directly attached to each other.

6. The article of footwear of claim 1, wherein the outsole body is directly attached to the one or more tread cleats.

7. The article of footwear of claim 1, wherein the first polyurethane polymeric material of the outsole body and the second polyurethane polymeric material of the footwear upper are different materials.

8. The article of footwear of claim 7, wherein the first polyurethane polymeric material of the outsole body comprises an ester-based polyurethane, and the second polyurethane polymeric material of the footwear upper comprises an ether-based polyurethane.

9. The article of footwear of claim 1, wherein the first polyurethane polymeric material of the outsole body comprises a tensile strength in a range of greater than or equal to 900 psi to less than or equal to 1100 psi, and/or the nitrile butadiene rubber polymeric material of the tread cleats comprises a tensile strength in a range of greater than or equal to 1025 psi to less than or equal to 2700 psi as measured by ASTM D412-16(2021).

10. The article of footwear of claim 1, wherein the first polyurethane polymeric material of the outsole body comprises a modulus in a range of less than or equal to 300 psi to greater than or equal to 200 psi, and/or the nitrile butadiene rubber polymeric material of the tread cleats comprises a modulus in a range of less than or equal to 350 psi to greater than or equal to 255 psi as measured by ASTM D412-16(2021).

11. The article of footwear of claim 1, wherein the first polyurethane polymeric material of the outsole body comprises a specific gravity in a range of greater than or equal to 0.55 g/ml to less than or equal to 0.95 g/ml, and/or the nitrile butadiene rubber polymeric material of the tread cleats comprises a specific gravity in a range of greater than or equal to 1.0 g/ml to less than or equal to 1.5 g/ml as measured by ASTM D792-20.

12. The article of footwear of claim 1, wherein the tread cleats are compression-molded.

13. The article of footwear of claim 1, wherein the outsole comprises a forepart section, an arch-shank section, and a heel section.

14. The article of footwear of claim 13, wherein a surface area of the heel section comprises greater than or equal to 20% to less than or equal to 45% of the tread cleats.

15. The article of footwear of claim 13, wherein a surface area of the heel section comprises at least 21% of the tread cleats.

16. The article of footwear of claim 13, wherein a surface area of the forepart section comprises greater than or equal to 20% to less than or equal to 30% of the tread cleats.

17. The article of footwear of claim 13, wherein a surface area of the forepart section comprises at least 23% of the tread cleats.

18. A liquid protection boot comprising:
an outsole comprising: an outsole body comprising a first polyurethane polymeric material, the outsole body being overmolded and directly attached to two or more compression-molded tread cleats, the tread cleats comprising a nitrile butadiene rubber (NBR) polymeric material; and
a liquid proof footwear upper affixed to the outsole, the footwear upper comprising a second polyurethane polymeric material different from the first polyurethane polymeric material;
wherein the liquid protection boot comprises one or more of the following:
a coefficient of friction of greater than or equal to 0.4 between a forward heel and a dry surface as measured by ASTM F2913-19,
a coefficient of friction of greater than or equal to 0.4 between a forward heel and a wet surface as measured by ASTM F2913-19,
a coefficient of friction of greater than or equal to 0.4 between a backward forepart and a dry surface as measured by ASTM F2913-19; and/or
a coefficient of friction of greater than or equal to 0.4 between a backward forepart and a wet surface as measured by ASTM F2913-19.

19. The liquid protection boot of claim 18, which is effective to meet or exceed slip resistance in accordance with ASTM F3445-21.

20. The liquid protection boot of claim 18, including one or more of the following:
the first polyurethane polymeric material of the outsole body comprises a tensile strength in a range of greater than or equal to 900 psi to less than or equal to 1100 psi, and/or the nitrile butadiene rubber polymeric material of the tread cleats comprises a tensile strength in a range of greater than or equal to 1025 psi to less than or equal to 2700 psi as measured by ASTM D412-16(2021);
the first polyurethane polymeric material of the outsole body comprises a modulus in a range of less than or equal to 300 psi to greater than or equal to 200 psi, and/or the nitrile butadiene rubber polymeric material of the tread cleats comprises a modulus in a range of less than or equal to 350 psi to greater than or equal to 255 psi as measured by ASTM D412-16(2021); and/or
the first polyurethane polymeric material of the outsole body comprises a specific gravity in a range of greater than or equal to 0.55 g/ml to less than or equal to 0.95 g/ml, and/or the nitrile butadiene rubber polymeric material of the tread cleats comprises a specific gravity in a range of greater than or equal to 1.0 g/ml to less than or equal to 1.5 g/ml as measured by ASTM D792-20.

21. A method of making an article of footwear comprising:
positioning one or more compression-molded tread cleats comprising a nitrile butadiene rubber polymeric material into one or more respective cavities of an outsole portion of a footwear mold;
injecting a first two-component polyurethane source into the outsole portion of the footwear mold and over the one or more compression-molded tread cleats;
injecting a second two-component polyurethane source into an upper portion of the footwear mold;
heating the footwear mold curing both the first and second two-component polyurethane sources to direct-attach an outsole body comprising a first polyurethane polymeric material that is overmolded to the one or more compression-molded tread cleats with a footwear upper comprising a second polyurethane polymeric material; and
removing the article of footwear from the footwear mold.

22. The method of claim 21, including one or more of the following:
the first polyurethane polymeric material of the outsole body comprises a tensile strength in a range of greater than or equal to 900 psi to less than or equal to 1100 psi, and/or the nitrile butadiene rubber polymeric material of the tread cleats comprises a tensile strength in a range of greater than or equal to 1025 psi to less than or equal to 2700 psi as measured by ASTM D412-16(2021);
the first polyurethane polymeric material of the outsole body comprises a modulus in a range of less than or equal to 300 psi to greater than or equal to 200 psi, and/or the nitrile butadiene rubber polymeric material of the tread cleats comprises a modulus in a range of less than or equal to 350 psi to greater than or equal to 255 psi as measured by ASTM D412-16(2021); and/or
the first polyurethane polymeric material of the outsole body comprises a specific gravity in a range of greater than or equal to 0.55 g/ml to less than or equal to 0.95 g/ml, and/or the nitrile butadiene rubber polymeric material of the tread cleats comprises a specific gravity in a range of greater than or equal to 1.0 g/ml to less than or equal to 1.5 g/ml as measured by ASTM D792-20. The method of claim 21, wherein the article of footwear comprises one or more of the following:
a coefficient of friction of greater than or equal to 0.4 between a forward heel and a dry surface as measured by ASTM F2913-19,
a coefficient of friction of greater than or equal to 0.4 between a forward heel and a wet surface as measured by ASTM F2913-19,
a coefficient of friction of greater than or equal to 0.4 between a backward forepart and a dry surface as measured by ASTM F2913-19; and/or
a coefficient of friction of greater than or equal to 0.4 between a backward forepart and a wet surface as measured by ASTM F2913-19.

24. The method of claim 21, wherein the article of footwear is effective to meet or exceed slip resistance in accordance with ASTM F3445-21.
